(19) United States
(12) Patent Application Publication
(10) Pub. No.: US 2025/0327670 A1
(43) Pub. Date: Oct. 23, 2025

(54) Temperature Characteristic Correction Method, Temperature Characteristic Correction Apparatus, And Sensor Device

(71) Applicant: SEIKO EPSON CORPORATION, Tokyo (JP)

(72) Inventor: Masaki GOMI, Matsumoto (JP)

(21) Appl. No.: 19/184,469

(22) Filed: Apr. 21, 2025

(30) Foreign Application Priority Data
Apr. 22, 2024 (JP) 2024-068892

(51) Int. Cl. G01C 21/16

(52) U.S. Cl. CPC G01C 21/183

(57) ABSTRACT

A sensor device includes an inertial sensor, a temperature sensor that detects a temperature of the inertial sensor, a storage unit that stores a temperature characteristic indicating a relationship between the temperature and an output value of the inertial sensor in each of a plurality of temperature ranges, and an arithmetic processing unit that derives a correction value for correction of the output value of the inertial sensor based on the temperature characteristic in the temperature range including the temperature detected by the temperature sensor and corrects the output value using the correction value.

The present application is based on, and claims priority from JP Application Serial Number 2024-068892, filed Apr. 22, 2024, the disclosure of which is hereby incorporated by reference herein in its entirety.

### BACKGROUND

### 1. Technical Field

The present disclosure relates to a temperature characteristic correction method, a temperature characteristic correction apparatus, and a sensor device.

### 2. Related Art

In the related art, it is known that output of an inertial sensor has a temperature characteristic. As a technique for correcting an output value for each temperature, for example, JP-A-2008-170294 is known. JP-A-2008-170294 discloses a technique of correcting an output signal from a detection circuit with a calibration curve of the second or higher order.

JP-A-2008-170294 is an example of the related art.

The output value of the inertial sensor may include a temperature characteristic. For example, even in a state in which the true value of the output value of the inertial sensor should be 0, when an output value other than 0 is output and the output value varies depending on the temperature, the relationship between the temperature and the output value is referred to as a temperature characteristic. In the temperature characteristic, the output value may suddenly change in a part of the use temperature zone, and the temperature characteristic may be complicated. For example, the output value may change rapidly in a specific temperature zone and have a peak, but the output value may change slowly with respect to the temperature in the other temperature zones. In the related art, it is difficult to correct the temperature characteristic of the inertial sensor that changes in a complicated manner in the use temperature zone.

### SUMMARY

A temperature characteristic correction method as an embodiment for solving the above described problem is a temperature characteristic method correction for correcting a temperature characteristic of an inertial sensor, including a first approximation step of deriving, based on an output value of the inertial sensor for each temperature, with respect to each case where i is 1 to n, n being an integer of 3 or more, an i-th output value at an i-th temperature from an i-th approximation curve indicating a relationship between a temperature in an i-th temperature range including the i-th temperature and the output value, a second approximation step of deriving, based on the i-th temperature and the i-th output value for i from 1 to n, with respect to each case where j is 1 to m, m being an integer of 2 or more, a j-th approximation curve in a j-th temperature range including a j-th temperature, and a correction step of deriving, based on the j-th approximation curve in the j-th temperature range including a correction target temperature, a correction value for correcting the output value of the inertial sensor at the correction target temperature, and correcting the output value of the inertial sensor using the correction value.

A temperature characteristic correction apparatus as an embodiment for solving the problem is a temperature characteristic correction apparatus that corrects a temperature characteristic of an inertial sensor, wherein, based on an output value of the inertial sensor for each temperature, with respect to each case where i is 1 to n, n being an integer of 3 or more, an i-th output value at an i-th temperature is derived from an i-th approximation curve indicating a relationship between a temperature in an i-th temperature range including the i-th temperature and the output value, based on the i-th temperature and the i-th output value for i from 1 to n, with respect to each case where j is 1 to m, m being an integer of 2 or more, a j-th approximation curve in a j-th temperature range including a j-th temperature is derived, and, based on the j-th approximation curve in the j-th temperature range including a correction target temperature, a correction value for correcting the output value of the inertial sensor at the correction target temperature is derived, and the output value is corrected using the correction value.

A sensor device as an embodiment for solving the problem includes an inertial sensor, a temperature sensor that detects a temperature of the inertial sensor, a storage unit that stores a temperature characteristic indicating a relationship between the temperature and an output value of the inertial sensor in each of a plurality of temperature ranges, and an arithmetic processing unit that derives a correction value for correction of the output value of the inertial sensor based on the temperature characteristic in the temperature range including the temperature detected by the temperature sensor and corrects the output value using the correction value.

### BRIEF DESCRIPTION OF THE DRAWINGS

FIG. 1 shows a configuration example of a sensor device according to a first embodiment.

FIG. 2 shows an example of temperature characteristics of an inertial sensor.

FIG. 3 shows a result of correction of the temperature characteristics of the inertial sensor based on one approximate curve.

FIG. 4 shows a result of correction of the temperature characteristics of the inertial sensor based on an approximate curve for each temperature range.

FIG. 5 is a flowchart showing derivation of an approximate curve.

FIG. 6 shows an i-th temperature.

FIG. 7 shows output values for each i-th temperature.

FIG. 8 shows a j-th temperature range and a spline curve.

FIG. 9 is a flowchart showing correction processing.

### DESCRIPTION OF EMBODIMENTS

A preferred embodiment of the present disclosure will be described below in detail. The following embodiment does not unduly limit the contents of the present disclosure described in the claims, and not all the configurations described in the embodiment are necessarily essential as a solution of the present disclosure.

### (1) First Embodiment

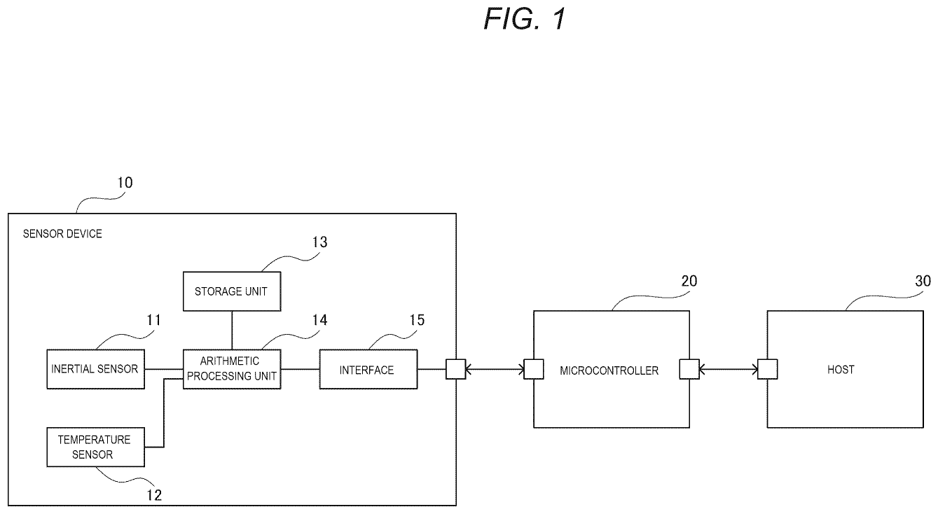

FIG. 1 shows a configuration example of a sensor device 10 of the embodiment. The sensor device 10 is a device that corrects and outputs an output value of an inertial sensor, and is coupled to a microcontroller 20. The microcontroller 20 is coupled to a host 30.

The sensor device 10 includes an inertial sensor 11, a temperature sensor 12, a storage unit 13, an arithmetic processing unit 14, and an interface 15. In the embodiment, the sensor device 10 is a device in which an integrated circuit device including the inertial sensor 11, the temperature sensor 12, the storage unit 13, the arithmetic processing unit 14, and the interface 15 is housed in a package. The integrated circuit device is an IC chip implemented by a semiconductor.

The inertial sensor 11 is a sensor element that detects a value related to inertia, and is a gyro sensor in the embodiment. That is, the inertial sensor 11 outputs a signal corresponding to an angular velocity around an axis of an object to be measured. The temperature sensor 12 is a sensor element that detects a value indicating a temperature. In the embodiment, the temperature sensor 12 is provided in the vicinity of the inertial sensor 11 and outputs a value indicating the temperature of the inertial sensor 11.

The storage unit 13 is a storage medium that can store various types of information, and is a nonvolatile memory such as an EEPROM (Electrically Erasable Programmable Read-Only Memory) in the embodiment. In the embodiment, the storage unit 13 stores a temperature characteristic indicating a relationship between the temperature and the output value of the inertial sensor. The temperature characteristic is an output value of the inertial sensor 11 at each temperature in a stationary state. In the embodiment, the temperature characteristic is described by a third-order expression that approximately indicates the relationship between the temperature and the output value. Accordingly, the coefficients of the third-order expression are stored in the storage unit 13.

In the embodiment, the temperature range in which the inertial sensor 11 is used is divided into a plurality of temperature ranges, and the temperature characteristic in each of the temperature ranges is described by a third-order expression. Accordingly, the coefficients of the third-order expression are defined for each temperature range and stored in association with the temperature range in the storage unit 13.

The arithmetic processing unit 14 includes an analog circuit and an A/D conversion circuit that converts an analog signal from the analog circuit into digital data. The analog circuit includes a circuit for detecting signals from the inertial sensor 11 and the temperature sensor 12. For example, the analog circuit may include an amplification circuit that amplifies a signal, a detection circuit such as a synchronous detection circuit, a gain adjustment circuit, an offset adjustment circuit, and the like. The A/D conversion circuit is a circuit that converts output of the analog circuit into a digital value.

The arithmetic processing unit 14 further includes a processor that performs predetermined processing based on the digital value, that is, the output value of the inertial sensor 11. In the embodiment, the arithmetic processing unit 14 acquires the current temperature of the inertial sensor 11 as a correction target temperature based on the detection value of the temperature sensor 12. Further, the arithmetic processing unit 14 acquires a coefficient indicating the temperature characteristic in the temperature range including the correction target temperature from the storage unit 13. Furthermore, the arithmetic processing unit 14 derives a correction value for correction of the output value of the inertial sensor 11 based on the coefficient. In the embodiment, the arithmetic processing unit 14 corrects the output value of the inertial sensor 11 by subtracting the correction value from the output value of the inertial sensor 11 indicating an angular velocity at the correction target temperature (when the correction value is negative, deleting the negative sign of the correction value and adding the correction value).

The interface 15 is a circuit for communicating with the microcontroller 20, and is, for example, a circuit for transmitting and receiving serial data. The communication standard is not limited, but, for example, a communication standard such as SPI or I2C or a communication standard obtained by improvement or modification of a part of the standard of SPI or I2C can be employed.

The microcontroller 20 is a processor that can execute various types of processing, and is coupled to the sensor device 10 and the host 30. When the detection data output from the sensor device 10 is input to the microcontroller 20, the microcontroller 20 executes various types of processing based on the detection data. The processing executed by the microcontroller 20 may be various types of processing. For example, the microcontroller 20 may perform processing according to a command from the host 30, may perform alignment correction for correcting a deviation of the attitude of the sensor device 10 from an ideal attitude, correction of a scale factor or non-linearity, or the like. In the embodiment, the microcontroller 20 is an integrated circuit device, and can be implemented by a processor such as an MPU, a CPU, or a DSP. Further, the microcontroller 20 may be implemented by an ASIC using automatic placement and routing such as a gate array.

The host 30 is a computer that gives various instructions to the microcontroller 20 and acquires various data output by the microcontroller 20. The host 30 issues, for example, a read request or a write request to the microcontroller 20. In the embodiment, the host 30 can cause the sensor device 10 to output and acquire the corrected value of the output value of the inertial sensor 11 by a read command.

In the above described configuration, the arithmetic processing unit 14 of the sensor device 10 corrects the output value of the inertial sensor 11 based on the approximate curve indicating the temperature characteristic for each temperature range stored in the storage unit 13. Therefore, correction with higher accuracy can be performed as compared with a configuration in which the output value of the inertial sensor 11 is corrected based on one approximate curve indicating the temperature characteristics in the entire temperature range.

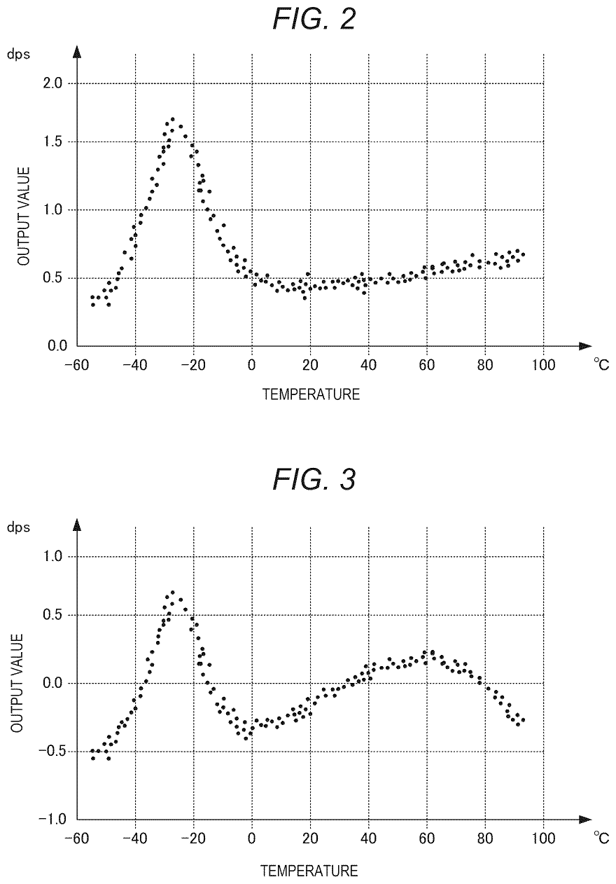

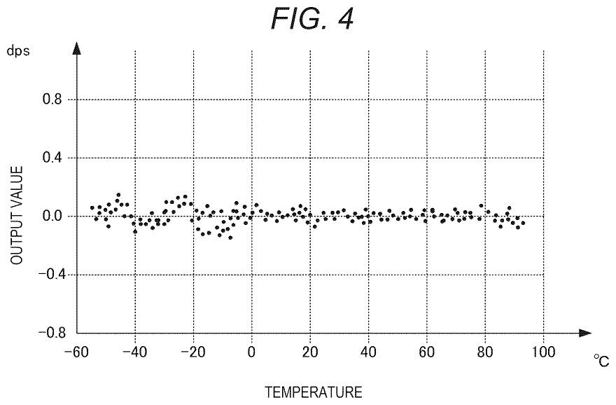

FIGS. 2 to 4 show how the output value is corrected. FIG. 2 shows an example of temperature characteristics of the inertial sensor 11. FIG. 3 shows a result of correction of the temperature characteristics of the inertial sensor 11 based on one approximate curve. FIG. 4 shows a result of correction of the temperature characteristics of the inertial sensor 11 based on an approximate curve for each temperature range. In these figures, the horizontal axis represents temperature (° C.) and the vertical axis represents an output value (dps: degree per second).

The use temperature zone in which the inertial sensor 11 according to the example is used is a range from −50° C. to 90° C. In FIG. 2, the output value at each temperature in a state where the inertial sensor 11 is stationary is indicated by a black circle. That is, the measurement was performed in a situation where the output value of the inertial sensor 11 should be 0 at all the temperatures. As shown in FIG. 2, in the temperature characteristics of the inertial sensor 11, there are a temperature zone in which the output value changes rapidly with respect to the temperature and a temperature zone in which the output value changes slowly. For example, in a temperature zone from −50° C. to 0° C., the output value rapidly increases as the temperature rises from −50° C., the output value reaches a peak near −30° C., and the output value rapidly decreases as the temperature further rises. On the other hand, the output value does not change much in a temperature zone of 0° C. or higher.

As described above, the output value of the inertial sensor 11 changes in a complicated manner in the use temperature zone. It is very difficult to approximate such a complicated change by one multi-order approximate expression. When the order of the approximate expression is increased, the approximation accuracy is improved, but the improvement of the accuracy is often insufficient. FIG. 3 is a graph in which the temperature characteristics in the use temperature zone are approximated by one third-order approximate expression, and a value obtained by subtraction of the approximate value at each temperature indicated by the approximate expression from the output value of the inertial sensor 11 at each temperature is plotted. As shown in FIG. 3, the magnitude of the output value tends to be smaller than that in FIG. 2, however, the output value after correction is also complicated due to the complicated change shown in FIG. 2. As a result, the correction accuracy is low, and the correction accuracy varies depending on the temperature.

On the other hand, the use temperature zone is divided into a plurality of temperature ranges and the temperature characteristic in each temperature range is approximated and corrected by a multi-order approximation expression in each temperature range, and thereby, the correction accuracy can be improved. FIG. 4 shows an example of a case where the temperature characteristic of the use temperature zone is divided and the temperature characteristic in each temperature range after the division is approximated and corrected by a third-order approximate expression. That is, FIG. 4 is a graph in which processing of plotting a value obtained by subtraction of the approximate value at each temperature indicated by the approximate expression from the output value of the inertial sensor 11 at each temperature is performed for each temperature range. As shown in FIG. 4, the magnitude of the output value is smaller than that in FIG. 2, and the correction accuracy is substantially equal in all the temperature ranges.

### (1-1) Derivation of Approximate Curve

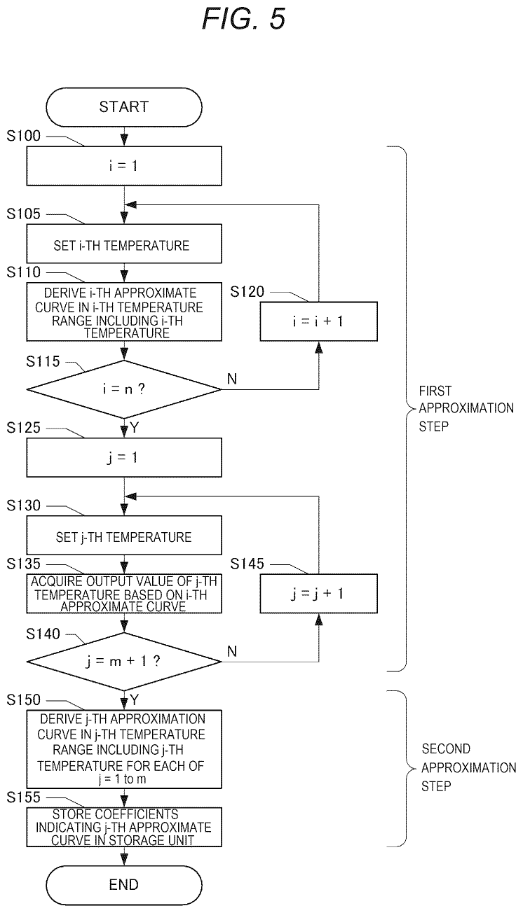

In the embodiment, as described above, the use temperature zone is divided into a plurality of temperature ranges, and correction is performed using an approximate expression for each temperature range. Derivation of the approximate expression will be described below. FIG. 5 is a flowchart showing derivation of an approximate curve. Steps S100 to S140 shown in FIG. 5 are a first approximation step, and steps S150 to S155 are a second approximation step. The processing can be realized by a measurement device of the output value of the inertial sensor 11 and a computer that performs processing based on a measurement result in the measurement device.

The first approximation step is processing for specifying output values at a plurality of temperatures in the use temperature zone of the inertial sensor 11. Here, these plurality of temperatures are referred to as an i-th temperature (i is an integer of 1 to n, and n is an integer of 3 or more), and (an approximate value of) an output value at the i-th temperature is referred to as an i-th output value. In the first approximation step, first, a variable i for specification of the i-th temperature is initialized to 1 (step S100).

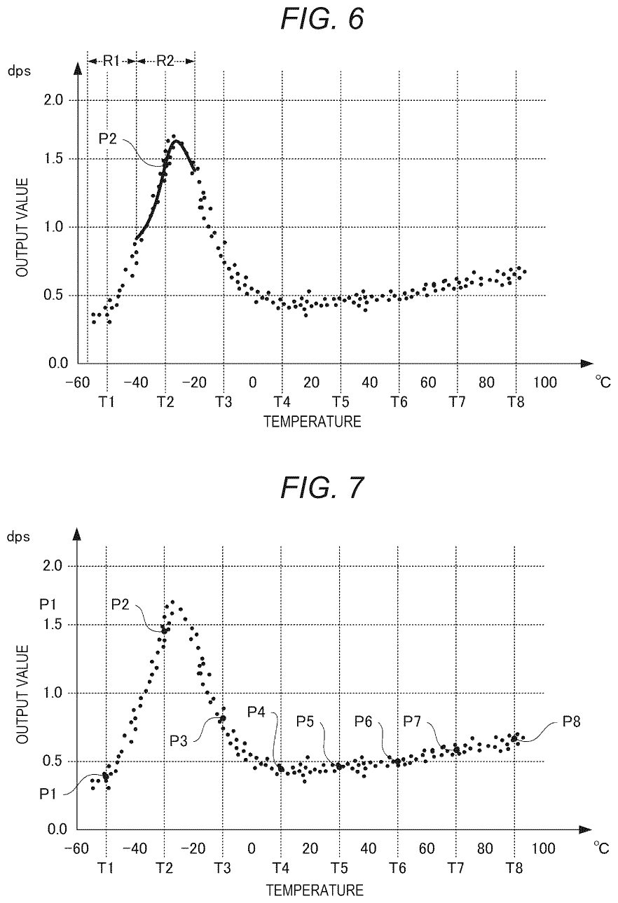

Then, the i-th temperature is set (step S105). The i-th temperature is a plurality of temperatures in the use temperature zone. The i-th temperature may be determined by various methods, and for example, a configuration in which the i-th temperature is set at regular intervals in the use temperature zone can be employed. FIG. 6 shows the same temperature characteristics as the temperature characteristics of the inertial sensor 11 shown in FIG. 2, and a first temperature T1 to an eighth temperature T8 are exemplified in the graph. Each temperature shown in FIG. 6 is an example, and the first temperature T1 may be larger than the lower limit value of the use temperature zone, and the eighth temperature T8 may be smaller than the upper limit value of the use temperature zone.

Then, a j-th approximate curve in an i-th temperature range including the i-th temperature is derived (step S110). The i-th temperature range is a temperature zone including the i-th temperature, and is provided over a predetermined range at least one of a lower range and a higher range than the i-th temperature. The size of the temperature range is optional, and is, for example, a predetermined size. Here, an example is assumed in which the i-th temperature range is set across the i-th temperature at each of the i-th temperatures. In FIG. 6, a second temperature range R2 set around the second temperature T2 and a first temperature range R1 set around the first temperature T1 are exemplified.

When the i-th temperature range is set, an i-th approximate curve is derived based on the output value at each temperature within the i-th temperature range. In the embodiment, the i-th approximate curve is a curve represented by a third-order expression. The third-order expression is defined, for example, by specification of each coefficient of the third-order expression by a least squares method using the output value at each temperature in the i-th temperature range. In FIG. 6, a second approximate curve in the second temperature range R2 is indicated by a solid curve.

Then, whether the variable i coincides with n as the maximum value of the variable i is determined (step S115), and when a non-coincidence is determined, the variable i is incremented (step S120), and the processing after step S105 is repeated. In step S115, when a determination that the variable i coincides with n is made, since the first approximate curve to the n-th approximate curve corresponding to the first temperature T1 to the n-th temperature Tn, respectively, have been already derived, the second approximate step after step S125 is started.

In step S125, first, a variable j for specification of the j-th temperature is initialized to 1 (step S125). Then, the j-th temperature is set based on the i-th approximate curve derived in the first approximation step (step S130). Here, the j-th temperature is a plurality of temperatures in the use temperature zone, and is a temperature serving as a boundary between spline curves as j-th approximate curves, which will be described later. The j-th temperature may be determined by various methods, and for example, a configuration in which the j-th temperature is set at regular intervals in the use temperature zone can be employed. The j-th temperature and the i-th temperature may be the same or different. Here, an example in which both are the same is described. In the example shown in FIG. 6, the j-th temperature is the temperatures T1 to T8 shown in FIG. 6.

Then, the output value of the j-th temperature is acquired based on the i-th approximate curve (step S135). That is, the j-th temperature is substituted into the i-th approximate curve, and the output value of the inertial sensor 11 at the j-th temperature is acquired. FIG. 6 shows a point P2 indicating the output value at the second temperature T2. The output value at the j-th temperature is acquired based on the i-th approximate curve, and can also be said to be an approximate value of the output value of the inertial sensor 11. Here, i=j, and the approximate value corresponds to the i-th output value at the i-th temperature.

Then, whether the variable j coincides with m+1 (m+1 is the maximum value of the variable j) is determined (step S140), and when a non-coincidence is determined, the variable j is incremented (step S145), and the processing after step S130 is repeated. In step S140, when a determination that the variable j coincides with m+1 is made, the output values corresponding to the first temperature T1 to the (m+1)-th temperature Tm+1, respectively, are acquired. FIG. 7 shows points P1 to P8 indicating output values corresponding to the first temperature T1 to the eighth temperature T8, respectively.

Then, a j-th approximate curve including the j-th temperature is derived for each of j=1 to m (step S150). In the embodiment, the spline curve is derived, and thereby, the j-th approximate curve is derived. The derivation of the spline curve can be realized by a known method. Specifically, since m+1 points Pj indicating the output value at the j-th temperature are generated, m third-order expressions having these P1 to Pm+1 as boundaries are defined, and each coefficient is specified.

A third-order expression yⱼ representing the j-th approximate curve is expressed as follows, for example.

$${y}_{j} = {{a}_{3 , j} ( T - {T}_{j} )}^{3} + {{a}_{2 , j} ( T - {T}_{j} )}^{2} + {a}_{1 , j} ( T - {T}_{j} ) + {a}_{0 , j}$$

Here, T is the temperature, Tⱼ is the j-th temperature, a_{3,j}, a_{2,j}, a_{1,j}, and a_{0,j} are a third-order coefficient, a second-order coefficient, a first-order coefficient, and a zero-order coefficient, respectively.

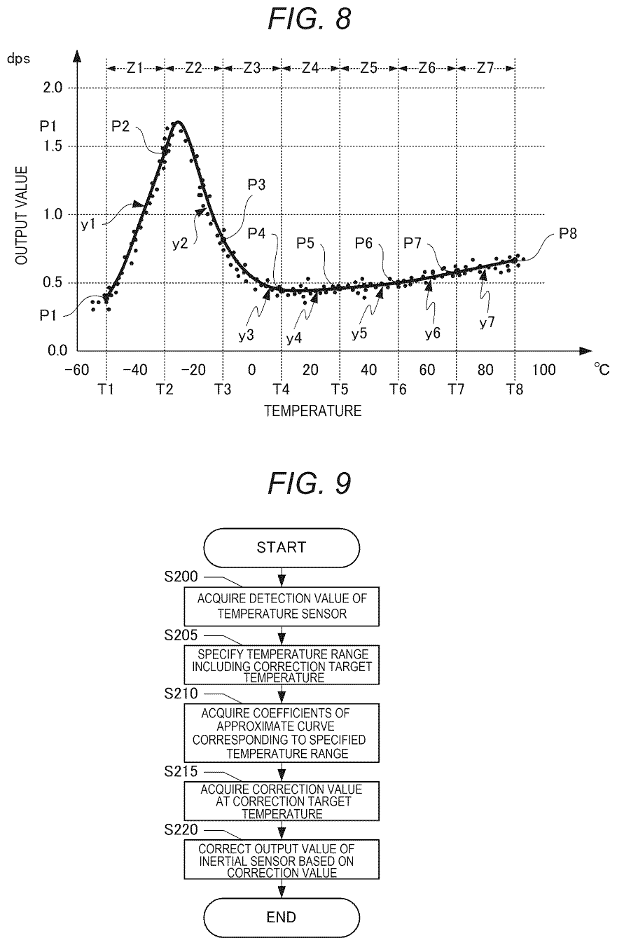

The j-th approximate curve is a third-order expression in the j-th temperature range (an interval from Tj to Tj+1), and m j-th approximate curves are defined. In FIG. 8, the j-th temperature range is shown as a range Zj, and a total of seven ranges Z1 to Z7 are shown. The third-order expression yⱼ representing the j-th approximate curve is an approximate expression in each range Zj. A continuous curve constituted by these m approximate expressions is the spline curve, and is derived by solving 4 m simultaneous equations based on the following conditions, for example.
Condition 1: The spline curve passes through all of the m points P1 to Pm.
Condition 2: A first-order derivative is continuous from the point P2 to the point Pm-1.
Condition 3: A second-order derivative is continuous from the point P2 to the point Pm-1.
Condition 4: The second-order derivative is 0 at points P1 and Pm.

When the coefficients are specified by solving the simultaneous equations, all of the m third-order expressions are defined, and the spline curve is defined. In FIG. 8, seven third-order expressions, that is, y1 to y7 are indicated by solid curves. The spline curve shown in FIG. 8 is constituted by third-order expressions with respect to each of the plurality of temperature ranges, and is defined to smoothly change at the j-th temperatures as boundaries under the above described conditions. Therefore, the spline curve is a curve that smoothly changes in the use temperature zone of the inertial sensor 11. Further, the spline curve is defined by division of the use temperature zone into a plurality of temperature ranges and definition of separate third-order expressions in the respective temperature ranges. Therefore, the temperature characteristic of the inertial sensor that changes in a complicated manner can be accurately reproduced as compared with a configuration in which the approximate curve is generated by one multi-order expression over the entire use temperature zone.

As described above, when the j-th approximate curve is obtained for each of j=1 to m, the coefficients indicating the j-th approximate curve are stored in the storage unit 13 (step S155). That is, each of the coefficients indicating the j-th approximate curve is stored in the storage unit 13 in association with the j-th temperature range. This processing is performed, for example, by outputting a write command from the host 30 to the storage unit 13. That is, when the write command is output, the microcontroller 20 acquires the values of the coefficients associated with the j-th temperature range from the host 30 and stores the values in the storage unit 13 of the sensor device 10.

### 1-2 Correction Processing

Next, correction processing based on the temperature characteristic stored in the storage unit 13 is described. FIG. 9 is a flowchart showing the correction processing executed by the arithmetic processing unit 14. When the supply of power to the sensor device 10 is started, the arithmetic processing unit 14 periodically executes the correction processing shown in FIG. 9. In the correction processing, the arithmetic processing unit 14 acquires the detection value of the temperature sensor 12 (step S200). That is, the arithmetic processing unit 14 specifies the current temperature of the inertial sensor 11 based on the detection value of the temperature sensor 12 and regards the current temperature as the correction target temperature.

Then, the arithmetic unit 14 processing specifies a temperature range including the correction target temperature (step S205). That is, the arithmetic processing unit 14 refers to the storage unit 13 and specifies the temperature range including the correction target temperature from the j-th temperature range.

Then, the arithmetic processing unit 14 acquires the coefficients of the approximate curve corresponding to the specified temperature range (step S210). That is, the arithmetic processing unit 14 refers to the storage unit 13 and acquires a third-order coefficient, a second-order coefficient, a first-order coefficient, and a zero-order coefficient associated with the temperature range specified in step S205.

Then, the arithmetic processing unit 14 acquires a correction value at the correction target temperature (step S215). That is, the arithmetic processing unit 14 regards the coefficients acquired in step S210 as the coefficients of the expression yⱼ=a_{3,j}(T−Tⱼ)³+a_{z, j}(T−Tⱼ)²+a_{1,j}(T−Tⱼ)+a_{0,j}, defines a third-order expression by substituting the j-th temperature corresponding to the temperature range, and substitutes the correction target temperature in the third-order expression.

The j-th temperature corresponding to the temperature range is substituted to define a third-order equation, and correction the target temperature is substituted into the third-order equation. The arithmetic processing unit 14 acquires the obtained value as a correction value at the correction target temperature.

Then, the arithmetic processing unit 14 corrects the output value of the inertial sensor 11 based on the correction value (step S220). That is, the calculation processing unit 14 corrects the output value of the inertial sensor 11 by subtracting the correction value from the output value of the inertial sensor 11 (when the correction value is negative, the negative sign of the correction value is deleted and the correction value is added). The arithmetic processing unit 14 outputs the corrected value to the microcontroller 20 via the interface 15.

In the above described configuration, the third-order expression as the approximate curve of the temperature characteristic is defined by each of the plurality of temperature ranges obtained by division of the use temperature zone. Therefore, the temperature characteristic of the inertial sensor that changes in a complicated manner can be accurately corrected as compared with a configuration in which the approximate curve is generated by one multi-order expression over the entire use temperature zone.

### 2 Other Embodiments

The above described embodiment is the example for implementation of the present disclosure, and various other embodiments can be employed. For example, the sensor device 10 is not limited to the configuration in FIG. 1 and various modifications such that part of the component elements are omitted or another component element is added can be made. For example, in FIG. 1, the microcontroller 20 controls the single sensor device 10, however, plurality of sensor devices may be coupled to the microcontroller 20 and the microcontroller 20 may perform processing based on the output of each sensor device. In this case, objects to be measured of the plurality of inertial sensors may be inertia with respect to the same axis or inertia with respect to different axes.

The arithmetic processing unit that corrects the output value based on the correction value may be the microcontroller 20. The i-th approximate curve and the j-th approximate curve are not limited to the third-order curves, but may be second-order curves or higher order curves. The sensor device may be used for various applications. For example, the device may be used in various electronic apparatuses, in-vehicle apparatuses, and the like. Examples of the in-vehicle apparatus include various navigation apparatuses and automated driving control apparatuses. Further, the device may be used for a positioning apparatus that determines a position of a vehicle.

The inertial sensor may be any sensor that detects a value for evaluation of inertia, for example, an acceleration sensor, an angular acceleration sensor, or a velocity sensor. The temperature characteristic is a relationship between the temperature and the output of the inertial sensor. The output of the inertial sensor in the temperature characteristic may be the output value itself, or may be a value subjected to bias correction by subtraction of a certain bias value from the output value.

The first approximation step may be a step of deriving the i-th approximate curve based on the output value of the inertial sensor for each temperature and deriving the i-th output value at the i-th temperature. That is, in the first approximation step, the output value at a plurality of temperatures (i-th temperatures) may be derived based on the output value of the inertial sensor for each temperature. Therefore, the i-th approximate curve is not limited, but any curve that approximately reproduces the output value for each temperature can be the i-th approximate curve. The output values at a plurality of temperatures (i-th temperatures) may be derived without using the approximate curve. For example, the i-th output value at the i-th temperature may be derived based on a statistical value of the output value of the i-th temperature, a statistical value of the output values of the i-th temperature and the temperature around the i-th temperature, or the like.

i may be a number indicating each of a plurality of (n) temperatures, and may be 3 or more. For example, i may be set to be equal to the number of temperatures necessary for correction of the temperature characteristics of the inertial sensor. In addition, the upper limit value n of i may be larger as the temperature range for correction of the temperature characteristic is wider and as the order of the approximate curve used in the second approximation step is larger. The plurality of temperatures indicated by the i-th temperature may be temperatures at equal intervals or temperatures at unequal intervals.

In the second approximation step, the i-th temperature and the i-th output value when i is 1 to n, and the j-th approximation curve in the j-th temperature range may be derived. That is, in the second approximation step, the j-th approximation curve indicating the temperature characteristic in each of the plurality of temperature ranges may be derived based on the result of the first approximation step. Therefore, the j-th approximate curve is not limited, but any curve that approximately reproduces the output value for each temperature can be the j-th approximate curve. For example, the j-th approximate curve may be a multi-order curve or the like for each j-th temperature range in which differentiation or the like at a boundary may be discontinuous, not the spline curve.

j may be a number indicating each of a plurality of (m) temperatures, and may be 2 or more. For example, j may be set to be equal to the number of temperatures necessary for correction of the temperature characteristics of the inertial sensor. In addition, the upper limit value m+1 of j may larger as the temperature range for correction of the temperature characteristic is wider and as the order of the approximate curve used in the second approximation step is larger. The plurality of temperatures indicated by the j-th temperature may be temperatures at equal intervals or temperatures at unequal intervals.

In the correction step, a correction value for correction of the output value of the inertial sensor at the correction target temperature may be derived based on the j-th approximate curve in the j-th temperature range including the correction target temperature, and the output value may be corrected using the correction value. That is, the j-th temperature range including the correction target temperature is selected from the j-th approximate curve derived for the m temperature ranges, and the correction value at the correction target temperature is derived based on the j-th approximate curve indicating the temperature characteristic in the j-th temperature range. The correction value may be data for setting the error between the output value and the true value to 0 or approximately 0.

The temperature sensor may be a sensor that detects the temperature of the inertial sensor, and the correction target temperature is specified based on the detection value of the temperature sensor. For example, the current temperature detected by the temperature sensor is regarded as the correction target temperature. The number of temperature sensors is not limited, and for example, in a sensor unit in which a plurality of inertial sensors are used, a plurality of temperature sensors that detect the temperatures of the respective inertial sensors may be used, or the temperatures of the plurality of inertial sensors may be detected by one temperature sensor. The distance between the temperature sensor and the inertial sensor is optional as long as the temperature of the inertial sensor can be specified based on the detection value of the temperature sensor.

The storage unit may store the temperature characteristic indicating the relationship between the temperature and the output value of the inertial sensor in each of the plurality of temperature ranges. That is, the storage unit may store the output value and the data for specification of the correction value of the output value based on the correction target temperature. The data may be information indicating the coefficients of the above described j-th approximate curve, may be table data or the like indicating a correspondence relationship between a plurality of temperatures and output values, or may be in any form.

The arithmetic processing unit may derive a correction value for correction of the output value of the inertial sensor based on the temperature characteristic in the temperature range including the temperature detected by the temperature sensor, and correct the output value using the correction value. That is, the arithmetic processing unit may derive a correction value for setting the error between the output value of the correction target temperature and the true value to 0 or approximately 0 based on the temperature characteristic stored in the storage unit, and correct the output value of the inertial sensor using the correction value.

What is claimed is:

1. A temperature characteristic correction method for correcting a temperature characteristic of an inertial sensor, the temperature characteristic correction method comprising:
a first approximation step of deriving, based on an output value of the inertial sensor for each temperature, with respect to each case where i is 1 to n, n being an integer of 3 or more, an i-th output value at an i-th temperature from an i-th approximation curve indicating a relationship between a temperature in an i-th temperature range including the i-th temperature and the output value;
a second approximation step of deriving, based on the i-th temperature and the i-th output value for i from 1 to n, with respect to each case where j is 1 to m, m being an integer of 2 or more, a j-th approximation curve in a j-th temperature range including a j-th temperature; and
a correction step of deriving, based on the j-th approximation curve in the j-th temperature range including a correction target temperature, a correction value for correcting the output value of the inertial sensor at the correction target temperature, and correcting the output value using the correction value.

2. The temperature characteristic correction method according to claim 1, wherein
the i-th approximate curve is a curve represented by a third-order expression.

3. The temperature characteristic correction method according to claim 1, wherein
the j-th approximate curve is a curve represented by a third-order expression.

4. A temperature characteristic correction apparatus that corrects a temperature characteristic of an inertial sensor, wherein
based on an output value of the inertial sensor for each temperature, with respect to each case where i is 1 to n, n being an integer of 3 or more, an i-th output value at an i-th temperature is derived from an i-th approximation curve indicating a relationship between a temperature in an i-th temperature range including the i-th temperature and the output value,
based on the i-th temperature and the i-th output value for i from 1 to n, with respect to each case where j is 1 to m, m being an integer of 2 or more, a j-th approximation curve in a j-th temperature range including a j-th temperature is derived, and
based on the j-th approximation curve in the j-th temperature range including a correction target temperature, a correction value for correcting the output value of the inertial sensor at the correction target temperature is derived, and the output value is corrected using the correction value.

5. A sensor device comprising:
an inertial sensor;
a temperature sensor that detects a temperature of the inertial sensor;
a storage unit that stores a temperature characteristic indicating a relationship between the temperature and an output value of the inertial sensor in each of a plurality of temperature ranges; and
an arithmetic processing unit that derives a correction value for correction of the output value of the inertial sensor based on the temperature characteristic in the temperature range including the temperature detected by the temperature sensor and corrects the output value using the correction value.
